(19) United States
(12) Patent Application Publication
(10) Pub. No.: US 2026/0187329 A1
(43) Pub. Date: Jul. 2, 2026

(54) ELECTRONIC DEVICE AND OPERATION METHOD OF ELECTRONIC DEVICE

(71) Applicant: SAMSUNG ELECTRONICS CO., LTD., Suwon-si (KR)

(72) Inventor: Baekseok KO, Suwon-si (KR)

(73) Assignee: SAMSUNG ELECTRONICS CO., LTD., Suwon-si (KR)

(21) Appl. No.: 19/542,120

(22) Filed: Feb. 17, 2026

Related U.S. Application Data
(63) Continuation of application No. PCT/KR2024/010472, filed on Jul. 19, 2024.

(30) Foreign Application Priority Data
Aug. 30, 2023 (KR) 10-2023-0114802

(51) Int. Cl. G06F 30/3308; G06F 119/06

(52) U.S. Cl. CPC G06F 30/3308; G06F 2119/06

(57) ABSTRACT

An electronic device and a method of operating the electronic device for performing a simulation of a memory interface includes separating a channel model and an input/output buffer information specification (IBIS) model, shorting a transmitting terminal of the IBIS model and extracting a current profile for an entire logic circuit, identifying a logic circuit portion, a power delivery network (PDN), and a signal path; modeling electrical characteristics for the PDN and the signal path, and applying a temporary current source to the PDN o perform the simulation.

### CROSS-REFERENCE TO RELATED APPLICATIONS

This application is a continuation of International Application No. PCT/KR2024/010472, filed on July 19, 2024, which claims priority to Korean Patent Application No. 10-2023-0114802, filed on August 30, 2023, the disclosures of which are incorporated by reference herein in their entireties.

### BACKGROUND

### 1. Field

The disclosure relates to an electronic device and a method of operating the electronic device.

### 2. Description of Related Art

Various types of software are being developed to analyze signal integrity of memory interfaces. A memory may use a high-speed data bus to support fast data transmission and processing. However, problems such as signal noise, sampling errors, and crosstalk may occur due to high-speed data transmission, and signal integrity analysis may be performed to solve these problems.

### SUMMARY

An analysis of signal integrity may be performed by considering simultaneous switching noise (SSN) through simulation for all of double data rate (DDR), power delivery network (PDN), and signal channel. A lot of time and computing resources may be consumed for the simulation.

Based on the discussion described above, the disclosure provides a device and method for efficiently performing simulation for a memory interface.

According to an aspect of the disclosure, there is provided a method of operating an electronic device for performing a simulation of a memory interface, the method including: separating a channel model and an input/output buffer information specification (IBIS) model; shorting a transmitting terminal of the IBIS model and extracting a current profile for an entire logic circuit; identifying a logic circuit portion, a power delivery network (PDN), and a signal path; modeling electrical characteristics for the PDN and the signal path; and applying a temporary current source to the PDN o perform the simulation.

The electrical characteristics for the PDN and the signal path is performed using a spice model or a scattering matrix.

The applying the temporary current source to the PDN to perform the simulation may include identifying a ripple voltage.

The method may include applying noise generated at the ripple voltage to the IBIS model.

The method may include performing the simulation for the entire logic circuit.

The method may include identifying a schematic for the IBIS model, the signal path and the PDN.

The extracting the current profile may include: applying the IBIS model and the channel model to the entire logic circuit; and configuring a voltage of the PDN.

According to an aspect of the disclosure, there is provided an electronic device including: a memory storing instructions; at least one processor connected with the memory, wherein the instructions, when executed by the at least one processor, cause the electronic device to: separate a channel model and an input/output buffer information specification (IBIS) model; terminate a transmitting terminal of the IBIS model with a receiving terminal of the IBIS model and a capacitor of a physical line to extract a current profile for an entire logic circuit; identify a logic circuit portion, a power delivery network (PDN) and a signal path; model electrical characteristics for the PDN and the signal path; and apply a temporary current source to the PDN to perform a simulation.

The instructions, when executed by the at least one processor, may cause the electronic device to model the electrical characteristics for the PDN and the signal path using a spice model or a scattering matrix.

The instructions, when executed by the at least one processor, may cause the electronic device to apply the temporary current source to the PDN to perform the simulation to identify a ripple voltage.

The instructions, when executed by the at least one processor, may cause the electronic device to apply noise generated at the ripple voltage to the IBIS model.

The instructions, when executed by the at least one processor, may cause the electronic device to perform the simulation for the entire logic circuit.

The instructions, when executed by the at least one processor, may cause the electronic device to identify a schematic for the IBIS model, the signal path and the PDN.

The instructions, when executed by the at least one processor, may cause the electronic device to: apply the IBIS model and the channel model to the entire logic circuit; and configure a voltage of the PDN.

According to an aspect of the disclosure, there is provided a non-transitory computer-readable recording medium storing instructions that when executed by at least one processor, perform a method including: separating a channel model and an input/output buffer information specification (IBIS) model; shorting a transmitting terminal of the IBIS model and extracting a current profile for an entire logic circuit; identifying a logic circuit portion, a power delivery network (PDN), and a signal path; modeling electrical characteristics for the PDN and the signal path; and applying a temporary current source to the PDN o perform the simulation.

The modeling the electrical characteristics for the PDN and the signal path may be performed using a spice model or a scattering matrix.

The applying the temporary current source to the PDN to perform the simulation may include identifying a ripple voltage.

The method further may include applying noise generated at the ripple voltage to the IBIS model.

The method further may include performing the simulation for the entire logic circuit.

The method further may include identifying a schematic for the IBIS model, the signal path and the PDN.

The embodiments of the disclosure provide an effect of reducing time and computing resources consumed for setting of a control chip, optimization of signal line, and design of memory power in memory interface design.

Further, the embodiments of the disclosure provide an effect that in case that a user changes the shape of line or components (e.g., capacitor, resistor), a simulation of a memory interface may be performed without performing a simulation for a full channel.

Effects of the disclosure are not limited to the foregoing, and other unmentioned effects would be apparent to one of ordinary skill in the art from the following description.

### BRIEF DESCRIPTION OF THE DRAWINGS

The above and other aspects and/or features of embodiments of the disclosure will become more apparent from the following detailed description taken in conjunction with the accompanying drawings, in which:

FIG. 1 is a block diagram illustrating a configuration of an electronic device according to an embodiment.

FIG. 2 is a block diagram illustrating an electronic device according to an embodiment;

FIG. 3 illustrates an operation flow of an electronic device according to an embodiment.

FIG. 4 illustrates an operation flow of an electronic device according to an embodiment.

FIG. 5 illustrates an operation flow of an electronic device according to an embodiment.

FIG. 6 illustrates an operation flow of an electronic device according to an embodiment.

FIG. 7 illustrates an operation flow of an electronic device according to an embodiment.

FIG. 8 illustrates an example of current profile extraction of an electronic device according to an embodiment.

FIG. 9 illustrates a power delivery network portion, a logic circuit portion and a signal path portion according to an embodiment.

FIG. 10 illustrates an example in which an electronic device identifies a ripple voltage according to an embodiment.

FIG. 11 illustrates an example of simulation performance of an electronic device according to an embodiment.

In relation to the description of the drawings, the same or similar reference numerals may be used for the same or similar components.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

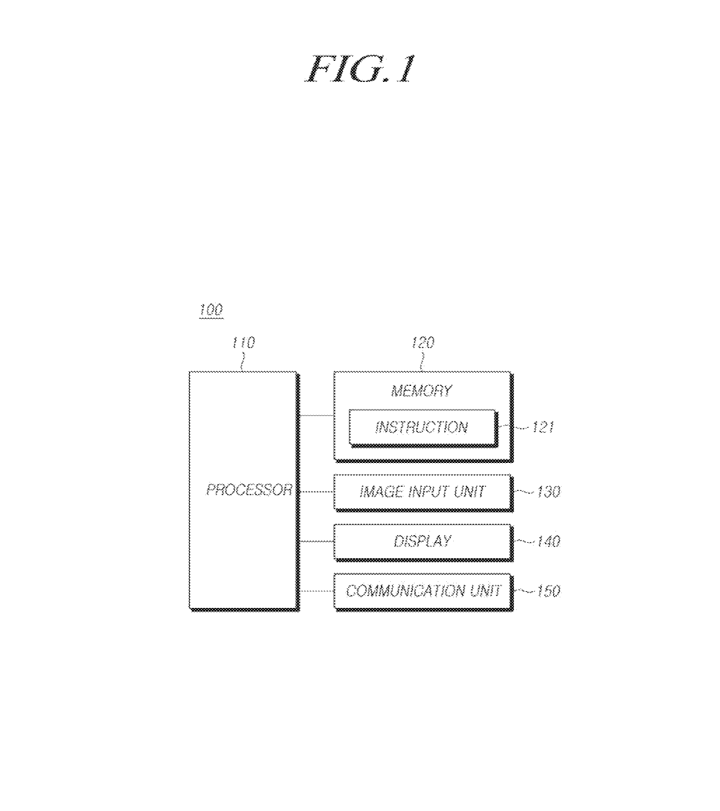

FIG. 1 is a block diagram illustrating a configuration of an electronic device according to an embodiment; The electronic device 100 may be wearable terminals, such as watches and glasses, capable of performing various computing functions, such as video watching and communication. The electronic device 100 may be various types of terminals without being limited to the above examples.

According to an embodiment, the memory 120 is a storage medium used by the electronic device 100 and may store data, such as at least one command 121 or configuration information corresponding to at least one program. The program may include an operating system (OS) program and various application programs.

In an embodiment, the memory 120 may store pairing information about an external electronic device located adjacent to the electronic device 100. In an embodiment, the pairing information may include, e.g., device information about the external electronic device, information about another external electronic device or remote control device paired with the external electronic device, information about a scheme (e.g., Bluetooth or Wi-Fi) in which the external electronic device and the other external electronic device or remote control device are paired with each other, and information about a pairing history between the external electronic device and the other external electronic device or remote control device.

In an embodiment, the memory 120 may include at least one type of storage medium of flash memory types, hard disk types, multimedia card micro types, card types of memories (e.g., SD or XD memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

According to an embodiment, the image input unit 130 may receive images and image information through a tuner (not shown), an input/output unit (not shown), or the communication unit 150. The image input unit 130 may include at least one of the tuner and the input/output unit. The tuner may tune and select only the frequency of the broadcast channel to be received by the electronic device 100 from among many radio wave components through amplification, mixing, resonance, or the like for the broadcast signal wiredly/wirelessly received. The broadcast signal may include video, audio, and additional data (e.g., electronic program guide (EPG)). The tuner may receive real-time broadcast channels (or real-time viewing images) from various broadcast sources, such as terrestrial broadcasts, cable broadcasts, satellite broadcasts, Internet broadcasts, and the like. The tuner may be implemented integrally with the electronic device 100 or may be implemented as a separate tuner electrically connected to the electronic device 100. The input/output unit may include at least one of a high definition multimedia interface (HDMI) input port, a component input jack, a PC input port, and a USB input jack capable of receiving an image and image information from an external device of the electronic device 100 under the control of the processor 110. It is obvious to one of ordinary skill in the art that the input/output unit may be added, deleted, and/or changed according to the performance and structure of the electronic device 100.

According to an embodiment, the display 140 may perform functions for outputting information in the form of numbers, characters, images, and/or graphics. The display 140 may include at least one hardware module for output. The at least one hardware module may include at least one of, e.g., a liquid crystal display (LCD), a light emitting diode (LED), a light emitting polymer display (LPD), an organic light emitting diode (OLED), an active matrix organic light emitting diode (AMOLED), or flexible LED (FLED). The display 140 may display a screen corresponding to data received from the processor 110. The display 140 may be referred to as an ‘output unit’, a ‘display unit’, or by other terms having an equivalent technical meaning.

According to an embodiment, the communication unit 150 may provide a wired/wireless communication interface enabling communication with an external device. The communication unit 150 may include at least one of a wired Ethernet, a wireless LAN communication unit, and a short-range communication unit. The wireless LAN communication unit may include, e.g., Wi-Fi, and may support the wireless LAN standard (IEEE802.11x) of the institute of electrical and electronics engineers (IEEE). The wireless LAN communication unit may be wirelessly connected to an access point (AP) under the control of the processor 110. The short-range communication unit may perform short-range communication wirelessly with an external device under the control of the processor 110. Short-range communication may include Bluetooth, Bluetooth low energy, infrared data association (IrDA), ultra wideband (UWB), and near-field communication (NFC). The external device may include a server device and a mobile terminal (e.g., phone, tablet, etc.) providing, e.g., a video service.

According to an embodiment, the processor 110 may control at least one other component of the electronic device 100 and/or execute computation or data processing regarding communication by executing at least one command 121 stored in the memory 120. The processor 110 may include at least one of a central processing unit (CPU), a graphic processing unit (GPU), a micro controller unit (MCU), a sensor hub, a supplementary processor, a communication processor, an application processor, an application specific integrated circuit (ASIC), or field programmable gate arrays (FPGA) and may have multiple cores.

In an embodiment, the processor 110 may execute, e.g., software to control at least one other component (e.g., a hardware or software component) of the electronic device 100 connected with the processor 110 and may process or compute various data. According to an embodiment, as at least part of the data processing or computation, the processor 110 may store a command or data received from another component onto a volatile memory, process the command or the data stored in the volatile memory, and store resulting data in a non-volatile memory. According to an embodiment, the processor 110 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor. For example, in case that the electronic device 100 includes the main processor and the auxiliary processor, the auxiliary processor may be configured to use lower power than the main processor or to be specified for a designated function. The auxiliary processor may be implemented separately from, or as part of, the main processor.

In an embodiment, the processor may obtain image frame data from at least one of the memory 120, the image input unit 130, or the communication unit 150. The image frame data may mean data regarding a frame constituting an image. For example, the image frame data may be stored in the memory 120 (e.g., an image recorded and stored). For example, the image frame data may be obtained from the communication unit 150 or the image input unit 130 (e.g., real-time streaming image).

In the following description, the connection between the processor 110 and the memory 120 is described using an example of a physical structure in which the processor 110 and a plurality of memory modules are disposed on a printed circuit board (PCB) and connected by a line. However, this is merely an example, and in addition to the described structure, various physical connection forms may include all various physical connection forms such as a dual in-line memory module (DIMM) interface form of connection through a slot, a multi-chip module, and a multi-chip package.

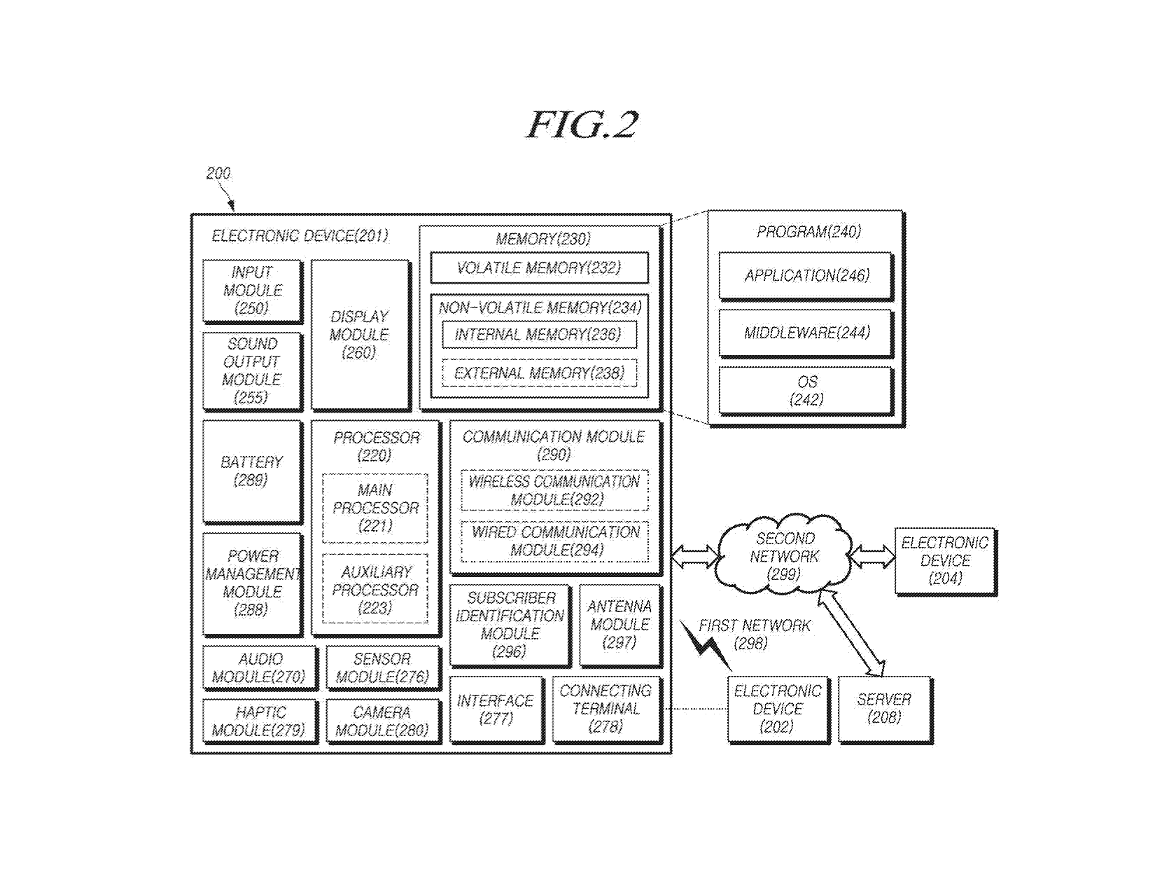

FIG. 2 is a block diagram illustrating an electronic device 201 in a network environment 200, according to various embodiments. Referring to FIG. 2, the electronic device 201 in the network environment 200 may communicate with at least one of an electronic device 202 via a first network 298 (e.g., a short-range wireless communication network), or an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, memory 230, an input module 250, a sound output module 255, a display module 260, an audio module 270, a sensor module 276, an interface 277, a connecting terminal 278, a haptic module 279, a camera module 280, a power management module 288, a battery 289, a communication module 290, a subscriber identification module (SIM) 296, or an antenna module 297. In an embodiment, at least one (e.g., the connecting terminal 278) of the components may be omitted from the electronic device 201, or one or more other components may be added in the electronic device 201. According to an embodiment, some (e.g., the sensor module 276, the camera module 280, or the antenna module 297) of the components may be integrated into a single component (e.g., the display module 260).

The processor 220 may execute, for example, software (e.g., the program 240) to control at least one other component (e.g., a hardware or software component) of the electronic device 201 coupled with the processor 220, and may perform various data processing or computation. According to an embodiment, as at least part of the data processing or computation, the processor 220 may store a command or data received from another component (e.g., the sensor module 276 or the communication module 290) in volatile memory 232, process the command or the data stored in the volatile memory 232, and store resulting data in non-volatile memory 234. According to an embodiment, the processor 220 may include a main processor 221 (e.g., a central processing unit (CPU) or an application processor (AP)), or an auxiliary processor 223 (e.g., a graphics processing unit (GPU), a neural processing unit (NPU), an image signal processor (ISP), a sensor hub processor, or a communication processor (CP)) that is operable independently from, or in conjunction with, the main processor 221. For example, in case that the electronic device 201 includes the main processor 221 and the auxiliary processor 223, the auxiliary processor 223 may be configured to use lower power than the main processor 221 or to be specified for a designated function. The auxiliary processor 223 may be implemented as separate from, or as part of the main processor 221.

The auxiliary processor 223 may control at least some of functions or states related to at least one component (e.g., the display module 260, the sensor module 276, or the communication module 290) among the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 223. According to an embodiment, the auxiliary processor 223 (e.g., the neural processing unit) may include a hardware structure specified for artificial intelligence model processing. The artificial intelligence model may be generated via machine learning. Such learning may be performed, e.g., by the electronic device 201 where the artificial intelligence is performed or via a separate server (e.g., the server 208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234.

The program 240 may be stored in the memory 230 as software, and may include, for example, an operating system (OS) 242, middleware 244, or an application 246.

The input module 250 may receive a command or data to be used by other component (e.g., the processor 220) of the electronic device 201, from the outside (e.g., a user) of the electronic device 201. The input module 250 may include, for example, a microphone, a mouse, a keyboard, keys (e.g., buttons), or a digital pen (e.g., a stylus pen).

The sound output module 255 may output sound signals to the outside of the electronic device 201. The sound output module 255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 260 may visually provide information to the outside (e.g., a user) of the electronic device 201. The display module 260 may include, for example, a display, a hologram device, or a projector and control circuitry to control a corresponding one of the display, hologram device, and projector. According to an embodiment, the display module 260 may include a touch sensor configured to detect a touch, or a pressure sensor configured to measure the intensity of a force generated by the touch.

The audio module 270 may convert a sound into an electrical signal and vice versa. According to an embodiment, the audio module 270 may obtain the sound via the input module 250, or output the sound via the sound output module 255 or a headphone of an external electronic device (e.g., an electronic device 202) directly (e.g., wiredly) or wirelessly coupled with the electronic device 201.

The sensor module 276 may detect an operation state (e.g., power or temperature) of the electronic device 201 or an external environmental state (e.g., the user’s state), and then generate an electrical signal or data value corresponding to the detected state. According to an embodiment, the sensor module 276 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, an HDMI connector, a USB connector, an SD card connector, or an audio connector (e.g., a headphone connector).

The haptic module 279 may convert an electrical signal into a mechanical stimulus (e.g., a vibration or motion) or electrical stimulus which may be recognized by a user via his tactile sensation or kinesthetic sensation. According to an embodiment, the haptic module 279 may include, for example, a motor, a piezoelectric element, or an electric stimulator.

The camera module 280 may capture a still image or moving images. According to an embodiment, the camera module 280 may include one or more lenses, image sensors, image signal processors, or flashes.

The power management module 288 may manage power supplied to the electronic device 201. According to an embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wiredly) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the application processor (AP)) and supports a direct (e.g., wired) communication or a wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device 204 via a first network 298 (e.g., a short-range communication network, such as Bluetooth^{TM}, wireless-fidelity (Wi-Fi) direct, or infrared data association (IrDA)) or a second network 299 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 292 may identify or authenticate the electronic device 201 in a communication network, such as the first network 298 or the second network 299, using subscriber information (e.g., international mobile subscriber identity (IMSI)) stored in the subscriber identification module 296.

The wireless communication module 292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 292 may support a high-frequency band (e.g., the mmWave band) to achieve, e.g., a high data transmission rate. The wireless communication module 292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 292 may support various requirements specified in the electronic device 201, an external electronic device (e.g., the electronic device 204), or a network system (e.g., the second network 299). According to an embodiment, the wireless communication module 292 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 297 may transmit or receive a signal or power to or from the outside (e.g., the external electronic device). According to an embodiment, the antenna module 297 may include one antenna including a radiator formed of a conductor or conductive pattern formed on a substrate (e.g., a printed circuit board (PCB)). According to an embodiment, the antenna module 297 may include a plurality of antennas (e.g., an antenna array). In this case, at least one antenna appropriate for a communication scheme used in a communication network, such as the first network 298 or the second network 299, may be selected from the plurality of antennas by, e.g., the communication module 290. The signal or the power may then be transmitted or received between the communication module 290 and the external electronic device via the selected at least one antenna. According to an embodiment, other parts (e.g., radio frequency integrated circuit (RFIC)) than the radiator may be further formed as part of the antenna module 297. According to various embodiments, the antenna module 297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 201 and the external electronic device 204 via the server 208 coupled with the second network 299. The external electronic devices 202 or 204 each may be a device of the same or a different type from the electronic device 201. According to an embodiment, all or some of operations to be executed at the electronic device 201 may be executed at one or more of the external electronic devices 202, 204, or 208. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, mobile edge computing (MEC), or client-server computing technology may be used, for example. The electronic device 201 may provide ultra low-latency services using, e.g., distributed computing or mobile edge computing. In another embodiment, the external electronic device 204 may include an Internet-of-things (IoT) device. The server 208 may be an intelligent server using machine learning and/or a neural network. According to an embodiment, the external electronic device 204 or the server 208 may be included in the second network 299. The electronic device 201 may be applied to intelligent services (e.g., smart home, smart city, smart car, or health-care) based on 5G communication technology or IoT-related technology.

A method of analyzing signal integrity of a memory interface by simultaneously simulating double data rate (DDR) memory, power delivery network, and signal channel may consume a lot of time and computing resources. Accordingly, the response speed for the result of computational analysis may be relatively slow, and time may be delayed for a user or machine viewing and judging the result to make real-time judgments about the next step. A user or circuit design device (e.g., electronic design automation (EDA) application program such as auto routing software) needs to perform low-latency analysis by fast response analysis in machine learning algorithm application or back processing of digital twin in case of designing a controller of a memory and a main system on chip (SoC), and a main SoC controller and high-speed interface circuit on a printed circuit board (PCB). The disclosure relates to a method for separating a power delivery network and a signal channel, performing simulation only for chip dynamic current to extract voltage ripple, and performing simulation only for the signal channel based on the extracted ripple voltage. According to embodiments of the disclosure, an electronic device may perform extraction of ripple voltage through modeling of a power delivery network, modeling of a power delivery network considering chip dynamic current, determination of whether ripple voltage occurs through modeling of a signal channel, analysis of signal channel integrity based on modeling results, and may analyze signal integrity of the entire memory interface by integrating PDN modeling results and signal channel modeling results.

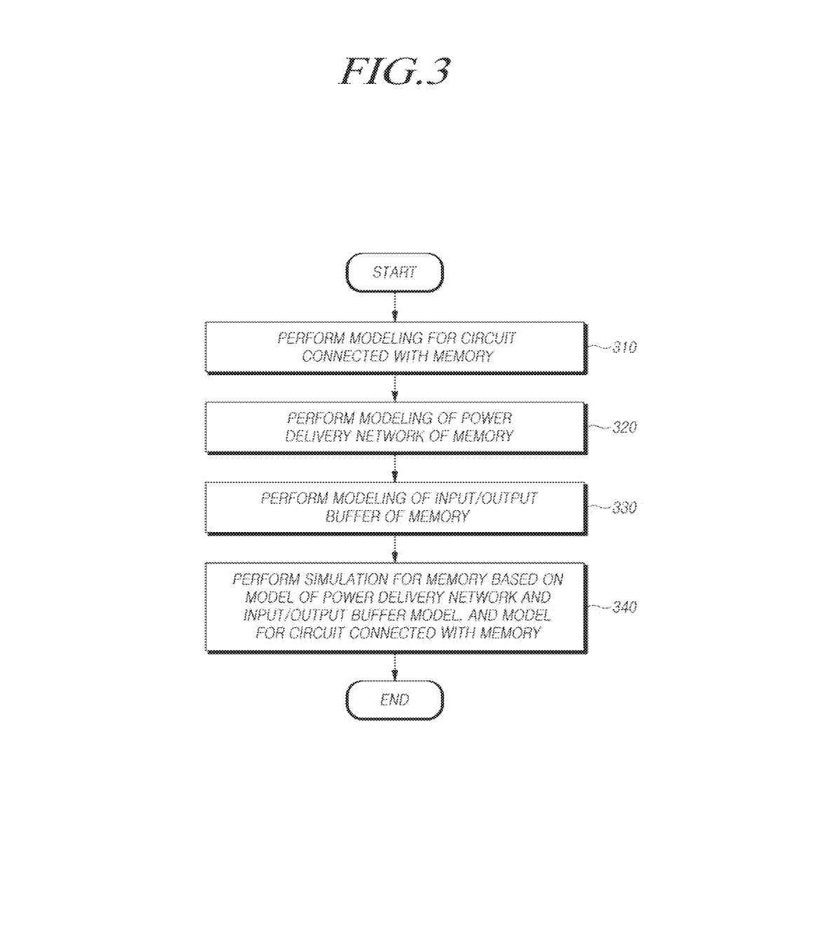

FIG. 3 illustrates an operation flow of an electronic device according to an embodiment. The electronic device of FIG. 3 may be a device corresponding to the electronic device 100 of FIG. 1 or the electronic device 201 of FIG. 2.

According to an embodiment, in operation 310, an electronic device may perform modeling for a circuit connected with a memory.

In an embodiment, the electronic device may perform modeling for the entire channel. The electronic device may model the entire path through which signals flow in a digital system. The electronic device may model electrical characteristics of the system including all components such as digital chips, traces, connections, packages, boards, and cables.

According to an embodiment, in operation 320, the electronic device may perform modeling of a power delivery network (PDN) of the memory. The electronic device may model a network through which power is provided in a digital system.

According to an embodiment, in operation 330, the electronic device may perform modeling of input/output buffers of the memory.

In an embodiment, the electronic device may import an input/output buffer information specification (IBIS) model.

According to an embodiment, in operation 340, the electronic device may perform simulation for the memory based on the model of the power delivery network, the input/output buffer model, and the model for the circuit connected with the memory.

In an embodiment, the electronic device may simulate the operation of signals in the entire path. The electronic device may perform simulation based on electrical characteristics of modeled digital chips, traces, packages, PCB, PDN and connections, and the IBIS model.

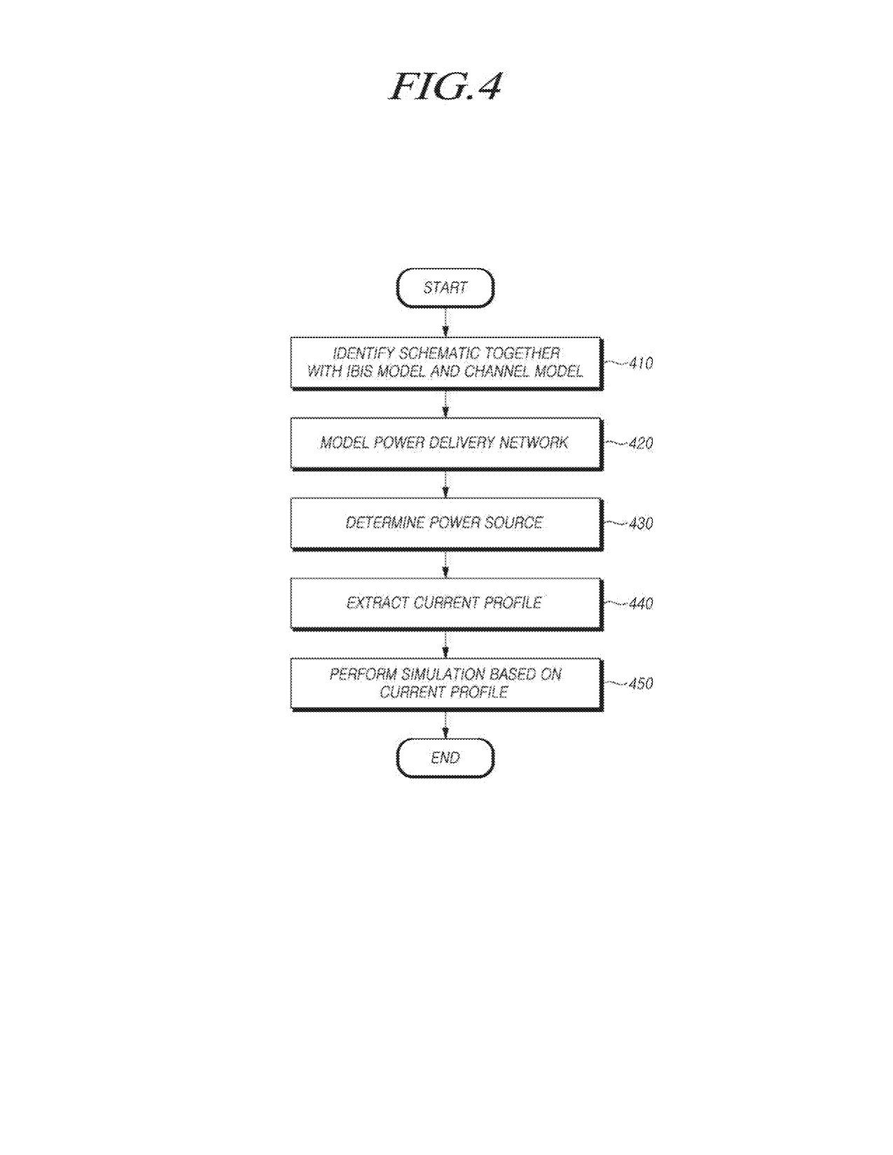

FIG. 4 illustrates an operation flow of an electronic device according to an embodiment. The electronic device of FIG. 4 may be a device corresponding to the electronic device 100 of FIG. 1, the electronic device 201 of FIG. 2, or the electronic device of FIG. 3. In the description of FIG. 4, descriptions of content overlapping with content described with reference to FIGS. 1 to 3 may be omitted.

According to an embodiment, in operation 410, an electronic device may identify a schematic together with an IBIS model and a channel model. The electronic device may create a circuit diagram for designing a digital system and may import an IBIS model and a channel model to be used in this circuit. The circuit diagram may include logical elements such as devices or gates. Components included in the circuit diagram may operate based on electrical characteristics defined by the IBIS model and the channel model.

According to an embodiment, in operation 420, the electronic device may model a power delivery network. The electronic device may model a power delivery network (PDN) within a digital system. The PDN is a system for stably providing power inside electronic products and may be used to evaluate and optimize the stability and performance of power supply.

According to an embodiment, in operation 430, the electronic device may determine a power source. The power source may refer to a power source to be used in case of simulating the PDN. In the simulation, a power source providing a specific voltage level or current may be set to simulate the operation of the circuit.

According to an embodiment, in operation 440, the electronic device may extract a current profile. The electronic device may extract characteristics of current to evaluate the possibility of damage occurring under specific conditions. The electronic device may model and evaluate characteristics of current occurring in expected events or conditions.

According to an embodiment, in operation 450, the electronic device may perform simulation based on the current profile.

In an embodiment, the electronic device may perform simulation considering simultaneous switching noise (SSN). SSN may refer to noise generated in case that multiple switches switch simultaneously. The electronic device may analyze signal integrity by modeling worst nets in the circuit and simulating SSN.

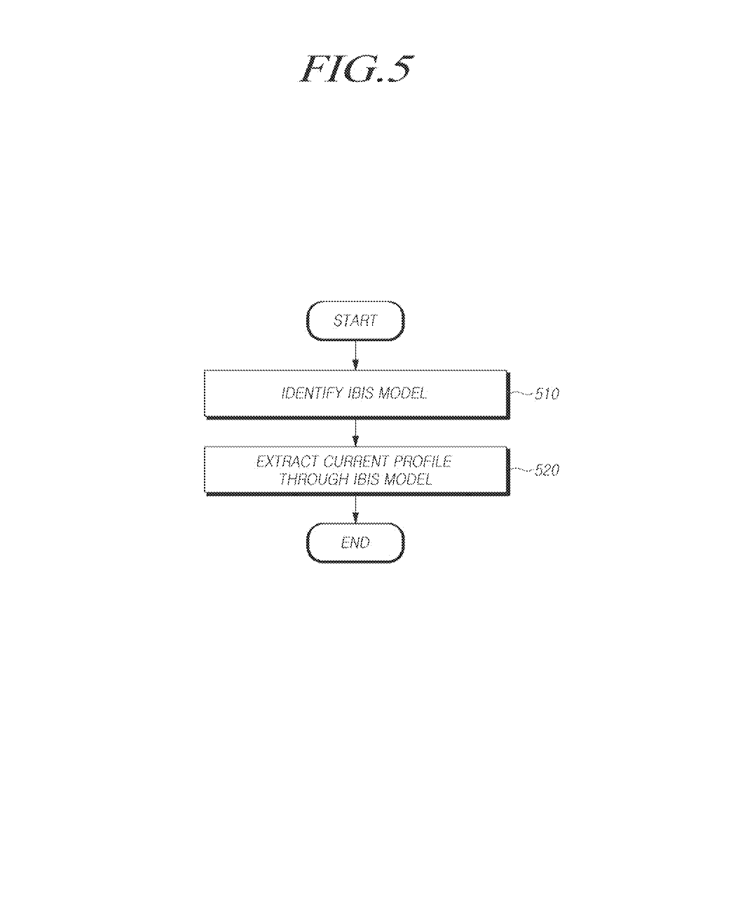

FIG. 5 illustrates an operation flow of an electronic device according to an embodiment. The electronic device of FIG. 5 may be a device corresponding to the electronic device 100 of FIG. 1, the electronic device 201 of FIG. 2, or the electronic device of FIGS. 3 and 4. FIG. 5 may be an operation of an electronic device related to the operation content of operation 440 of FIG. 4, and in the description of FIG. 5, description of content overlapping that described with reference to FIGS. 1 to 5 may be omitted.

According to an embodiment, in operation 510, an electronic device may identify an IBIS model. The IBIS model may describe electrical characteristics of input/output buffers used in a digital system. The IBIS model may define voltage-current characteristics, rise/fall time, voltage levels, etc. for input/output buffers of a device. The IBIS model may be used in simulation tools to perform signal integrity analysis.

According to an embodiment, in operation 520, the electronic device may extract a current profile through the IBIS model. The current profile may refer to data recording current changes occurring in an electronic device or system during a specific time period over time. Accordingly, a user may identify how current changes during operation of a PDN or electronic device. The current profile is data capturing dynamic current changes over time and may include information about the magnitude and direction of current, frequency, and aspects of current changes. In PDN modeling, it is possible to determine how much current is needed in the power delivery network while an electronic device operates, and how much voltage ripple or noise occurs. The electronic device may extract a current profile by performing simulation using the IBIS model.

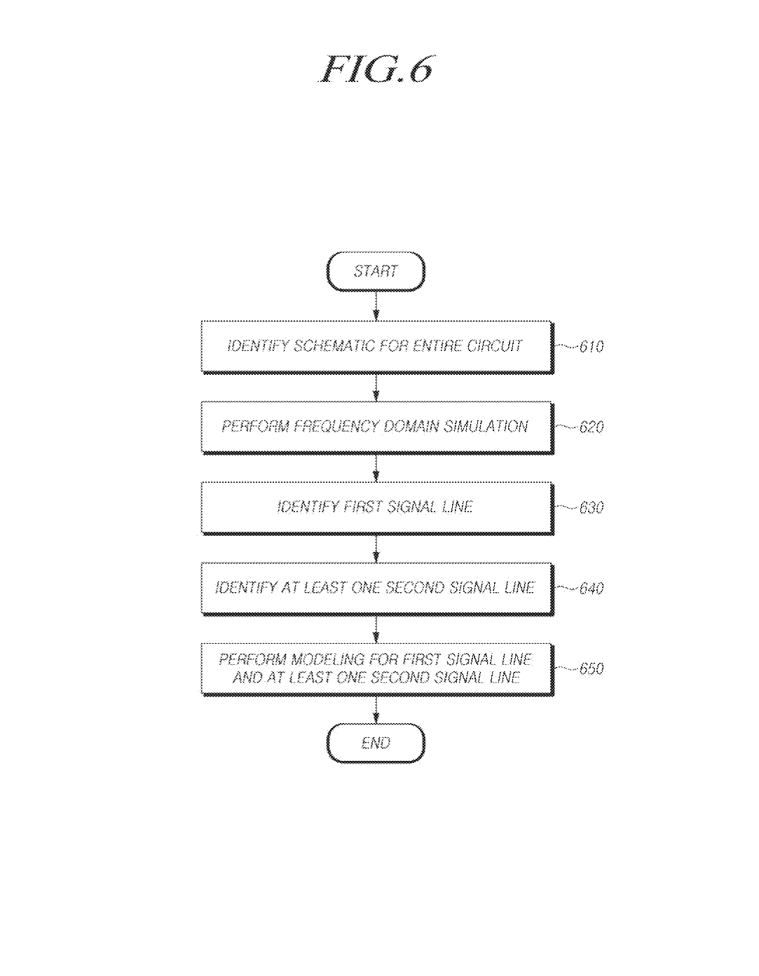

FIG. 6 illustrates an operation flow of an electronic device according to an embodiment. The electronic device of FIG. 6 may be a device corresponding to the electronic device 100 of FIG. 1, the electronic device 201 of FIG. 2, or the electronic device of FIGS. 3 to 5. FIG. 6 relates to an operation of an electronic device for performing operation 420 of FIG. 4. In the description of FIG. 6, descriptions of content overlapping with content described with reference to FIGS. 1 to 5 may be omitted.

According to an embodiment, in operation 610, an electronic device may identify a schematic for the entire circuit. The schematic for the entire circuit may include circuit diagrams for a printed circuit board (PCB), PKG(package), and components.

According to an embodiment, in operation 620, the electronic device may perform frequency domain simulation. Frequency domain simulation may refer to analyzing electrical characteristics of a system in the frequency domain. The output of operation 620 includes a general SPICE(simulation program with integrated circuit emphasis) format equivalent model or a scattering matrix (S-parameters) model as a result of modeling physical line.

According to an embodiment, in operation 630, the electronic device may identify a first signal line. The first signal line refers to a signal line most likely to have problems in the system, and the most vulnerable signal line in the system may be identified as the first signal line.

According to an embodiment, in operation 640, the electronic device may identify at least one second signal line. The second signal line may refer to a signal line determined to be adjacent to the first signal line. The second signal line may refer to a line where problems may occur due to interaction with the first signal line.

According to an embodiment, in operation 650, the electronic device may perform modeling for the first signal line and the at least one second signal line. This may be an operation corresponding to operation 420 of FIG. 4.

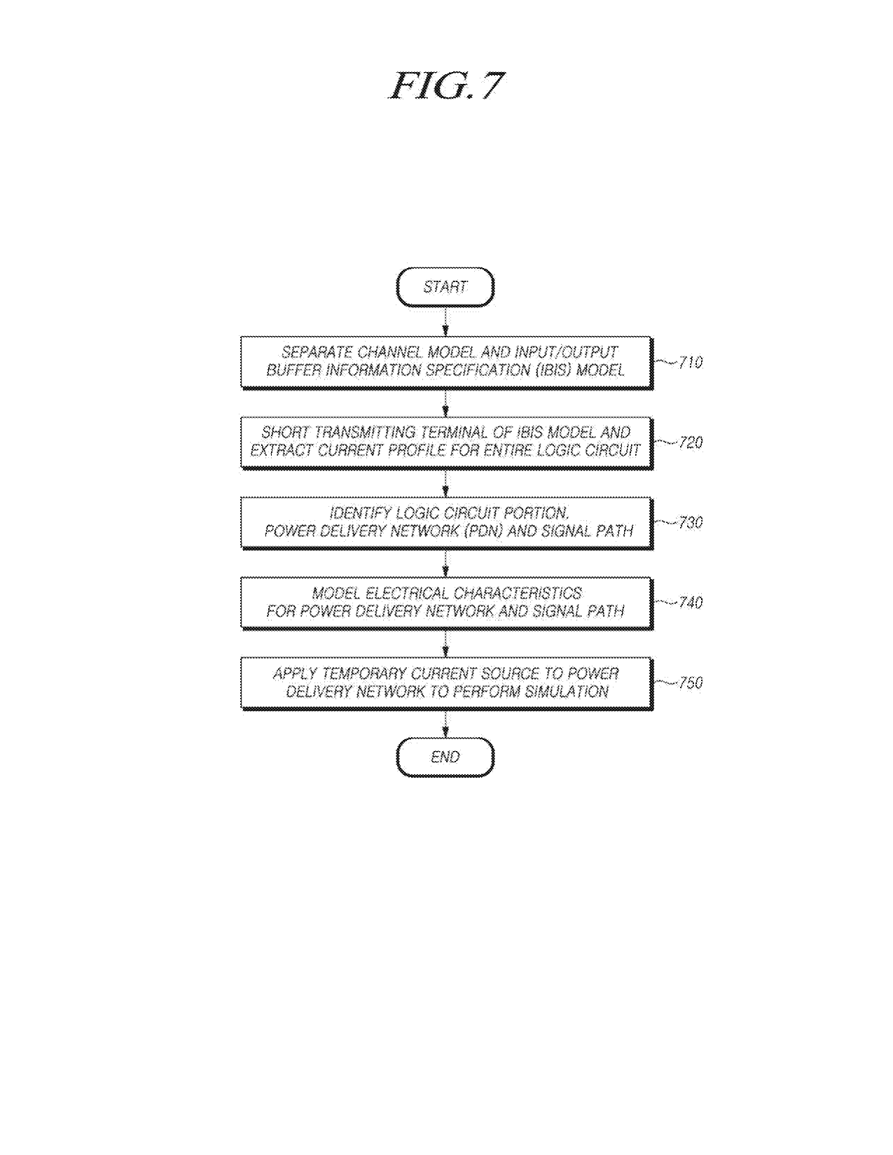

FIG. 7 illustrates an operation flow of an electronic device according to an embodiment. The electronic device of FIG. 7 may be a device corresponding to the electronic device 100 of FIG. 1, the electronic device 201 of FIG. 2, or the electronic device of FIGS. 3 to 6. FIG. 7 relates to an operation flow of an electronic device for performing simulation of a memory interface based on the operations of FIGS. 4 to 6.

According to an embodiment, in operation 710, an electronic device may split a channel model and an IBIS model.

According to an embodiment, in operation 720, the electronic device may short a transmitting terminal of the IBIS model and extract a current profile for an entire logic circuit.

In an embodiment, the electronic device may temporarily short a model on the transmission (Tx) side among IBIS models that model each input/output buffer operation to extract a current profile for the entire logic circuit. The electronic device may perform SPICE(simulation program with integrated circuit emphasis) model or S-parameter modeling for each power delivery network and signal path.

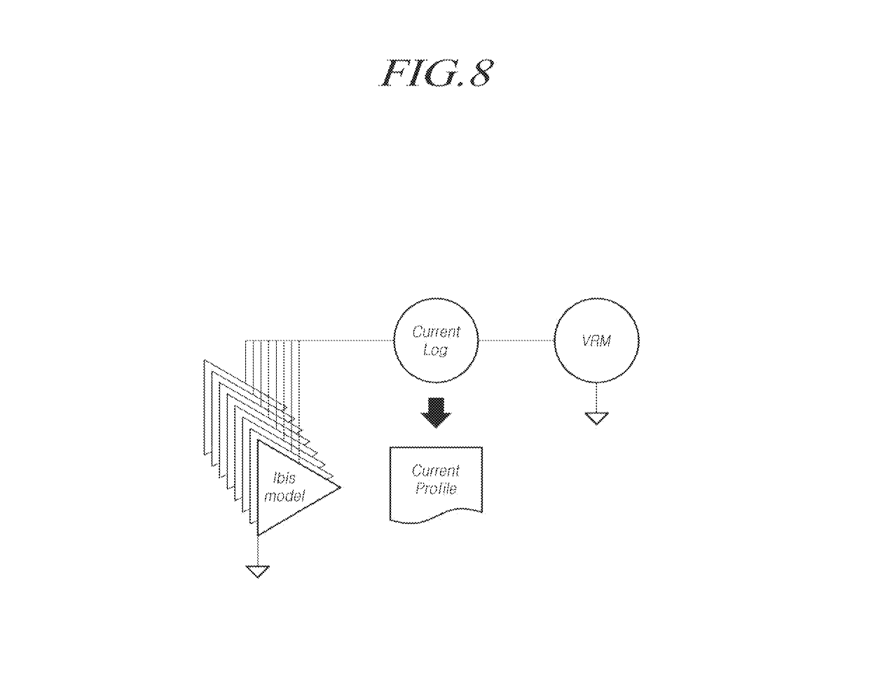

FIG. 8 illustrates an example of current profile extraction of an electronic device according to an embodiment.

Referring to FIG. 8, an electronic device may obtain a current profile for an entire logic circuit using an IBIS model.

According to an embodiment, in operation 730, the electronic device may identify a logic circuit portion, a power delivery network and a signal path.

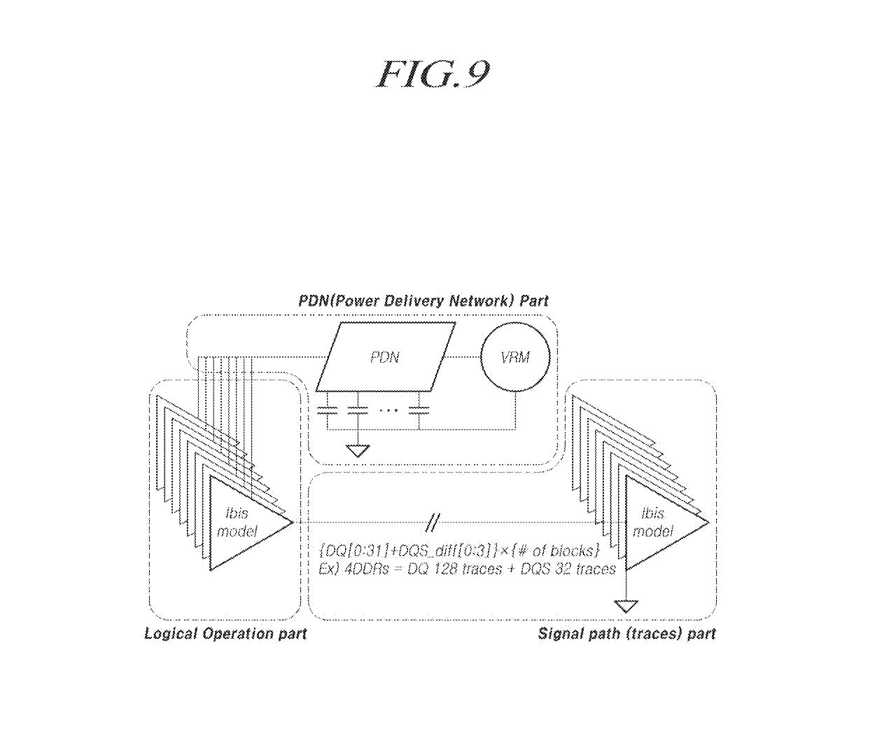

FIG. 9 illustrates a power delivery network portion, a logic circuit portion and a signal path portion according to an embodiment.

Referring to FIG. 9, an electronic device may identify a logic circuit portion (including IBIS model), a power delivery network portion (PDN), and a signal path portion respectively through operation 730.

According to an embodiment, in operation 740, the electronic device may model electrical characteristics for the power delivery network and the signal path.

According to an embodiment, in operation 750, the electronic device may apply a temporary current source to the power delivery network to perform simulation.

In an embodiment, the electronic device may identify a ripple voltage by applying a temporary current source to the power delivery network. The electronic device may record noise signals such as ripple voltage in the power delivery network to which a temporary current source is applied and perform simulation using the corresponding signal. Accordingly, the noise impact of the PDN may be analyzed and operation at the entire system level may be evaluated more accurately.

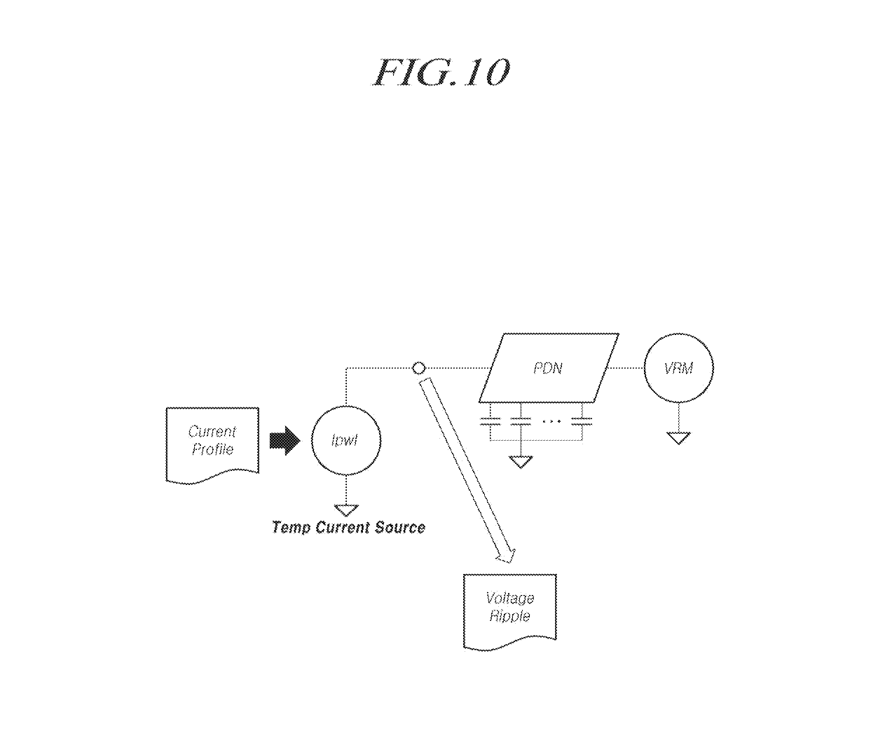

FIG. 10 illustrates an example in which an electronic device identifies a ripple voltage according to an embodiment.

Referring to FIG. 10, a ripple voltage may be identified from a current profile by applying a temporary current source to the power delivery network.

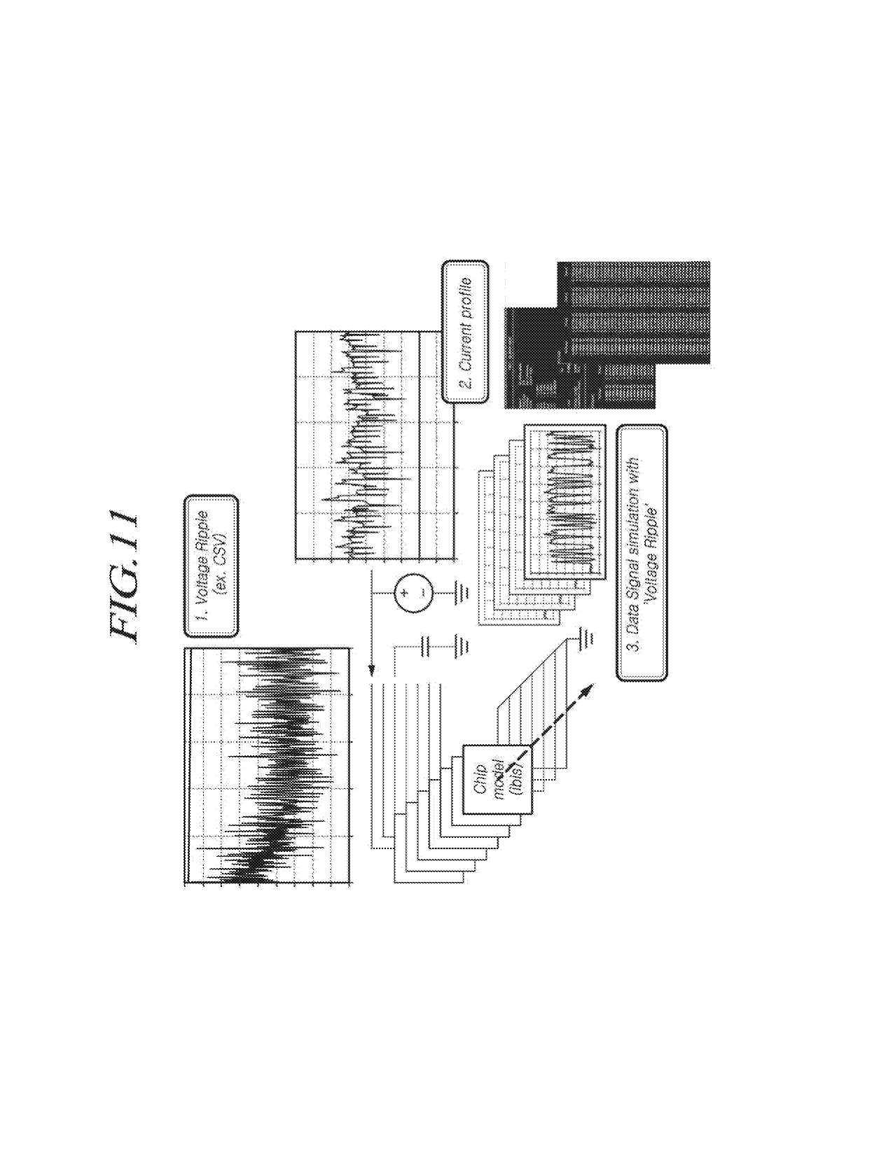

FIG. 11 illustrates an example of simulation performance of an electronic device according to an embodiment.

Referring to FIG. 11, an electronic device may identify a ripple voltage and simulate a data signal based on the current profile and the ripple voltage to analyze signal integrity.

Although not illustrated in the drawings, the electronic device may simulate the operation of the system using a voltage source (V DC) connected to the power delivery network. “on-off switched” means that the voltage source turns on or off after a predetermined time delay, and the operation of the system may be modeled by adjusting the timing in case that power is supplied to the power delivery network through such delay.

The electronic device may simulate the operation of the system using a current source connected to the power delivery network. “delay, switched” allows the current source to turn on or off immediately without delay, so the timing in case that power is supplied to the PDN may be modeled immediately. Accordingly, the electronic device may perform long-term time domain simulation. The electronic device may analyze voltage, current and operation over time occurring while the system operates for a long time.

A method of operating an electronic device for performing a simulation of a memory interface may include: separating a channel model and an input/output buffer information specification (IBIS) model; shorting a transmitting terminal of the IBIS model and extracting a current profile for an entire logic circuit; identifying a logic circuit portion, a power delivery network (PDN), and a signal path; modeling electrical characteristics for the PDN and the signal path; and applying a temporary current source to the PDN o perform the simulation.

In an embodiment, the operation of modeling electrical characteristics for the power delivery network and the signal path may be performed using a spice model or a scattering matrix.

In an embodiment, the operation of applying a temporary current source to the power delivery network to perform a simulation may include an operation of identifying a ripple voltage.

The method of operating an electronic device according to an embodiment may include an operation of applying noise generated at the ripple voltage to the IBIS model.

The method of operating an electronic device according to an embodiment may include an operation of performing a simulation for the entire logic circuit.

The method of operating an electronic device according to an embodiment may include an operation of identifying a schematic for the IBIS model, the signal path and the power delivery network.

In an embodiment, the operation of extracting the current profile may include an operation of applying the IBIS model and the channel model to the entire logic circuit, and an operation of configuring the voltage of the power delivery network.

An electronic device may include: a memory storing instructions; at least one processor connected with the memory, wherein the instructions, when executed by the at least one processor, may cause the electronic device to: separate a channel model and an input/output buffer information specification (IBIS) model; terminate a transmitting terminal of the IBIS model with a receiving terminal of the IBIS model and a capacitor of a physical line to extract a current profile for an entire logic circuit; identify a logic circuit portion, a power delivery network (PDN) and a signal path; model electrical characteristics for the PDN and the signal path; and apply a temporary current source to the PDN to perform a simulation.

In an embodiment, the processor may perform modeling of electrical characteristics for the power delivery network and the signal path using a spice model or a scattering matrix.

In an embodiment, the processor may apply a temporary current source to the power delivery network to perform a simulation to identify a ripple voltage.

In an embodiment, the processor may apply noise generated at the ripple voltage to the IBIS model.

In an embodiment, the processor may perform a simulation for the entire logic circuit.

In an embodiment, the processor may identify a schematic for the IBIS model, the signal path and the power delivery network.

In an embodiment, the processor may apply the IBIS model and the channel model to the entire logic circuit and configure the voltage of the power delivery network.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 240) including one or more instructions that are stored in a storage medium (e.g., internal memory 236 or external memory 238) that is readable by a machine (e.g., the electronic device 201). For example, a processor (e.g., the processor 220) of the machine (e.g., the electronic device 201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a non-transitory computer-readable recording medium storing instructions that when executed by at least one processor, perform a method including: separating a channel model and an input/output buffer information specification (IBIS) model; shorting a transmitting terminal of the IBIS model and extracting a current profile for an entire logic circuit; identifying a logic circuit portion, a power delivery network (PDN), and a signal path; modeling electrical characteristics for the PDN and the signal path; and applying a temporary current source to the PDN o perform the simulation.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smartphones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A method of operating an electronic device for performing a simulation of a memory interface, the method comprising:
separating a channel model and an input/output buffer information specification (IBIS) model;
shorting a transmitting terminal of the IBIS model and extracting a current profile for an entire logic circuit;
identifying a logic circuit portion, a power delivery network (PDN), and a signal path;
modeling electrical characteristics for the PDN and the signal path; and
applying a temporary current source to the PDN o perform the simulation.

2. The method of claim 1, wherein the modeling the electrical characteristics for the PDN and the signal path is performed using a spice model or a scattering matrix.

3. The method of claim 2, wherein the applying the temporary current source to the PDN to perform the simulation comprises identifying a ripple voltage.

4. The method of claim 3, further comprising applying noise generated at the ripple voltage to the IBIS model.

5. The method of claim 4, further comprising performing the simulation for the entire logic circuit.

6. The method of claim 5, further comprising identifying a schematic for the IBIS model, the signal path and the PDN.

7. The method of claim 1, wherein the extracting the current profile comprises:
applying the IBIS model and the channel model to the entire logic circuit; and
configuring a voltage of the PDN.

8. An electronic device comprising:
a memory storing instructions; and
at least one processor connected with the memory, wherein the instructions, when executed by the at least one processor, cause the electronic device to:
separate a channel model and an input/output buffer information specification (IBIS) model;
terminate a transmitting terminal of the IBIS model with a receiving terminal of the IBIS model and a capacitor of a physical line to extract a current profile for an entire logic circuit;
identify a logic circuit portion, a power delivery network (PDN) and a signal path;
model electrical characteristics for the PDN and the signal path; and
apply a temporary current source to the PDN to perform a simulation.

9. The electronic device of claim 8, wherein the instructions, when executed by the at least one processor, cause the electronic device to model the electrical characteristics for the PDN and the signal path using a spice model or a scattering matrix.

10. The electronic device of claim 9, wherein the instructions, when executed by the at least one processor, cause the electronic device to apply the temporary current source to the PDN to perform the simulation to identify a ripple voltage.

11. The electronic device of claim 10, wherein the instructions, when executed by the at least one processor, cause the electronic device to apply noise generated at the ripple voltage to the IBIS model.

12. The electronic device of claim 11, wherein the instructions, when executed by the at least one processor, cause the electronic device to perform the simulation for the entire logic circuit.

13. The electronic device of claim 12, wherein the instructions, when executed by the at least one processor, cause the electronic device to identify a schematic for the IBIS model, the signal path and the PDN.

14. The electronic device of claim 8, wherein the instructions, when executed by the at least one processor, cause the electronic device to:
apply the IBIS model and the channel model to the entire logic circuit; and
configure a voltage of the PDN.

15. A non-transitory computer-readable recording medium storing instructions that when executed by at least one processor, perform a method comprising:
separating a channel model and an input/output buffer information specification (IBIS) model;
shorting a transmitting terminal of the IBIS model and extracting a current profile for an entire logic circuit;
identifying a logic circuit portion, a power delivery network (PDN), and a signal path;
modeling electrical characteristics for the PDN and the signal path; and
applying a temporary current source to the PDN o perform the simulation.

16. The non-transitory computer-readable recording medium of claim 15, wherein the modeling the electrical characteristics for the PDN and the signal path is performed using a spice model or a scattering matrix.

17. The non-transitory computer-readable recording medium of claim 16, wherein the applying the temporary current source to the PDN to perform the simulation comprises identifying a ripple voltage.

18. The non-transitory computer-readable recording medium of claim 17, wherein the method further comprises applying noise generated at the ripple voltage to the IBIS model.

19. The non-transitory computer-readable recording medium of claim 18, wherein the method further comprises performing the simulation for the entire logic circuit.

20. The non-transitory computer-readable recording medium of claim 19, wherein the method further comprises identifying a schematic for the IBIS model, the signal path and the PDN.
